(19) United States
(12) Patent Application Publication
(10) Pub. No.: US 2023/0354499 A1
(43) Pub. Date: Nov. 2, 2023

(54) METHOD FOR THE REMOTE OPTIMIZATION OF A TASK LAMP

(71) Applicants: Peter Borden, San Mateo, CA (US); Michele Klein, Portola Valley, CA (US)

(72) Inventors: Peter Borden, San Mateo, CA (US); Michele Klein, Portola Valley, CA (US)

(21) Appl. No.: 18/127,467

(22) Filed: Mar. 28, 2023

Related U.S. Application Data
(60) Provisional application No. 63/335,481, filed on Apr. 27, 2022.

(51) Int. Cl. H05B 47/19; H05B 45/12; H05B 45/22

(52) U.S. Cl. CPC H05B 47/19; H05B 45/12; H05B 45/22

(57) ABSTRACT

A method for the remote optimization of a task lamp that provides a practitioner the ability to alter task lamp lighting to suit a particular user in that user's environment without requiring the practitioner to be present in the same location. To effect such a method the practitioner and the user may be connected remotely, preferably via a video call, and the practitioner may be able to remotely control a task lamp set up by the user at their own location. The task lamp may be wirelessly connected to the practitioner via built-in hardware and a proprietary software, or may be wirelessly connected to the user via built-in hardware and a proprietary software that is connected to the practitioner's proprietary software. The task lamp may also be adjusted by the user independently. It is to these ends that the present invention has been developed.

### TECHNICAL FIELD OF THE INVENTION

The present invention relates in general to lighting devices, and, more specifically, to a method for the remote optimization of a task lamp.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Task lighting provides local illumination, when desired, for such varied activities as reading, crafts, and fine work. Ambient lighting, by contrast, generally illuminates entire rooms, hallways, and other large areas.

Two important properties characterize lighting, namely: intensity and color. Intensity is the brightness of the light at the illuminated surface, and is commonly measured in units of lux. Color is the hue of the light, and may be either a single wavelength or a combination of wavelengths that defines a point in the Commission Internationale de l'Elcairage (CIE) color space. When discussing white and whitish light color is commonly associated with color temperature, ranging from warm to cold, measure in degrees Kelvin (° K). Task lamps typically span a range of about 2700° K to 6500° K.

Ambient lighting is available in both white and colored light. The Philips Hue bulb system, for example, combines light from red, green, and blue light emitting diodes (LEDs) to provide lighting in a wide range of hues, adjustable using a software application on a smart phone. A Philips Hue bulb placed in a desk lamp can provide task lighting in color.

Most lamps for task lighting are available in white light. Recently, lamps such as the Stella system combine light from white LEDs of different color temperatures to provide a selection of distinct color temperatures and a range of intensities. One Stella lamp model provides white light in three color temperatures with five intensities for each. Some models provide local remote control, using an infrared LED, similar to a local remote control used with a television set, of both the white color temperature and the intensity in discrete steps.

Smart devices such as e-readers and tablets are available with white and black backgrounds. The white background color temperature is sometimes adjustable to accommodate a user's preference or to control the amount of blue light emitted. For example, a user may wish to minimize the blue component of the background light while reading in the evening. This may be done by choosing a warmer color temperature for the white light.

It has been shown that colored light may reduce eye strain. For example, Goodrich, Borden, and Klein (“Can Color Improve Perceived Acuity,” Envision Conference 2016, Wichita, KS) presented to subjects a system with variable color placed over an eye chart, and asked them to select the color that made the characters on the chart clearest. Notably, 38 of 40 subjects chose colors in the green/blue range, and none chose white.

A task lamp or e-reader with adjustable hue can minimize eye strain when reading or performing fine tasks, where the hue is adjusted to match an individual's preference. However, it is difficult to find the best hue because the color space visible to the human eye is three dimensional (red, green, blue), spanning millions of possible hues.

Those with such vision difficulties often seek help from practitioners such as occupational therapists, ophthalmologists, and optometrists. These practitioners frequently recommend improvements or changes in task lighting to enhance visual performance, improve visual acuity, and reduce eye strain. Because the effect of task lighting is altered by the effect of ambient lighting proper adjustment of settings for a particular user often requires a home visit to set up the task lamp in the environment where it will be used, which may differ substantially from the practitioner's office. Such visits are time consuming, may require the transport of equipment such as lights, filters, and bulbs, and are often prohibitively expensive or otherwise not covered by insurance.

Thus, there is a need in the art for a method for the remote optimization of a task lamp that provides a practitioner the ability to alter task lamp lighting to suit a particular user in that user's environment without requiring the practitioner to be present in the same location. To effect such a method the practitioner and the user may be connected remotely, preferably via a video call, and the practitioner may be able to remotely control a task lamp set up by the user at their own location. The task lamp may be wirelessly connected to the practitioner via built-in hardware and a proprietary software, or may be wirelessly connected to the user via built-in hardware and a proprietary software that is connected to the practitioner's proprietary software. The task lamp may also be adjusted by the user independently. It is to these ends that the present invention has been developed.

### BRIEF SUMMARY OF THE INVENTION

To minimize the limitations in the prior art, and to minimize other limitations that will be apparent upon reading and understanding the present specification, the present invention describes a method for the remote optimization of a task lamp.

It is an objective of the present invention to provide a method for the remote optimization of a task lamp that utilizes a remotely located task lamp.

It is another objective of the present invention to provide a method for the remote optimization of a task lamp that utilizes a proprietary software.

It is another objective of the present invention to provide a method for the remote optimization of a task lamp that utilizes a practitioner interface.

It is another objective of the present invention to provide a method for the remote optimization of a task lamp that utilizes a client interface.

It is another objective of the present invention to provide a method for the remote optimization of a task lamp that may optimize the background hue of reading material using a visual sample.

It is another objective of the present invention to provide a method for the remote optimization of a task lamp that may optimize the background hue of reading material by comparing to a standard reference.

It is another objective of the present invention to provide a method for the remote optimization of a task lamp that may optimize the background hue of reading material by comparing to white light.

It is another objective of the present invention to provide a method for the remote optimization of a task lamp that may optimize the background hue of reading material that may provide pre-set values of hues.

It is another objective of the present invention to provide a method for the remote optimization of a task lamp that may comprise a smart device.

It is another objective of the present invention to provide a method for the remote optimization of a task lamp that may comprise a smart phone.

It is another objective of the present invention to provide a method for the remote optimization of a task lamp that may comprise a smart tablet.

It is another objective of the present invention to provide a method for the remote optimization of a task lamp that may comprise an e-reader.

It is another objective of the present invention to provide a method for the remote optimization of a task lamp that may comprise a wireless connectivity.

It is another objective of the present invention to provide a method for the remote optimization of a task lamp that may comprise a visual output.

It is another objective of the present invention to provide a method for the remote optimization of a task lamp that may comprise a measurement of contrast.

It is another objective of the present invention to provide a method for the remote optimization of a task lamp that may comprise a determination of intensity.

It is another objective of the present invention to provide a method for the remote optimization of a task lamp that may comprise a measurement of color contrast.

It is another objective of the present invention to provide a method for the remote optimization of a task lamp that may comprise an analysis of a screen shot of an area illuminated by the task lamp.

It is another objective of the present invention to provide a method for the remote optimization of a task lamp that may comprise a single-component construction.

It is another objective of the present invention to provide a method for the remote optimization of a task lamp that may comprise a multiple-component construction.

It is another objective of the present invention to provide a method for the remote optimization of a task lamp that may comprise a resilient material of construction.

It is another objective of the present invention to provide a method for the remote optimization of a task lamp that may comprise a cleanable material of construction.

It is another objective of the present invention to provide a method for the remote optimization of a task lamp that may comprise a reusable material of construction.

It is another objective of the present invention to provide a method for the remote optimization of a task lamp that may comprise an antimicrobial layer.

It is another objective of the present invention to provide a method for the remote optimization of a task lamp that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 schematically presents a method for the remote optimization of a task lamp, as contemplated by the present disclosure;

FIG. 2 illustrates a system structure of a method for the remote optimization of a task lamp, as contemplated by the present disclosure; and

FIG. 3 illustrates a method for the remote optimization of a task lamp, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

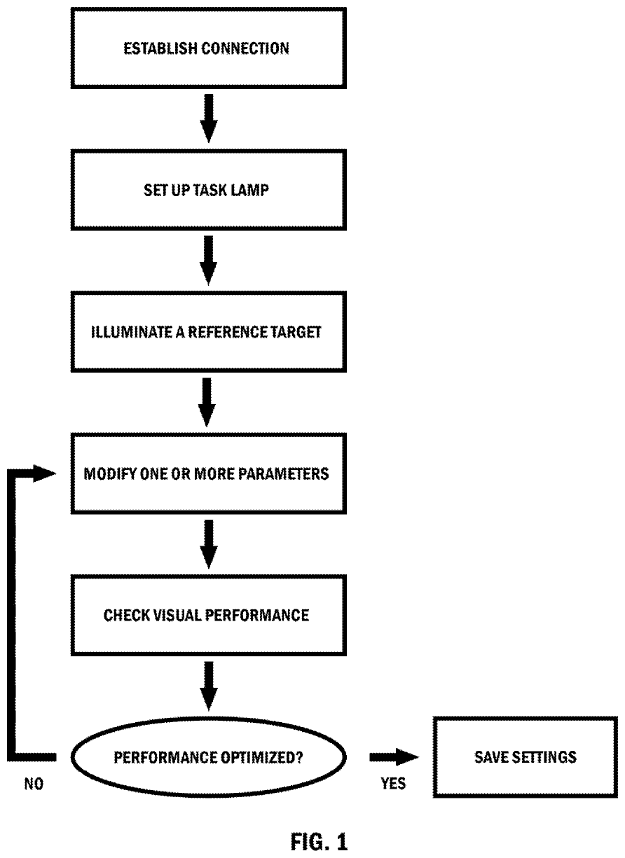

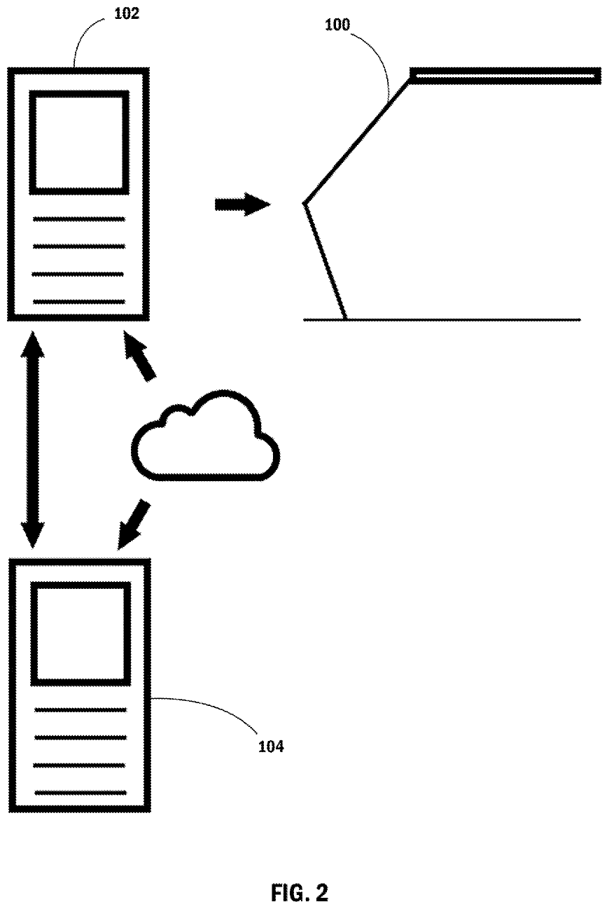

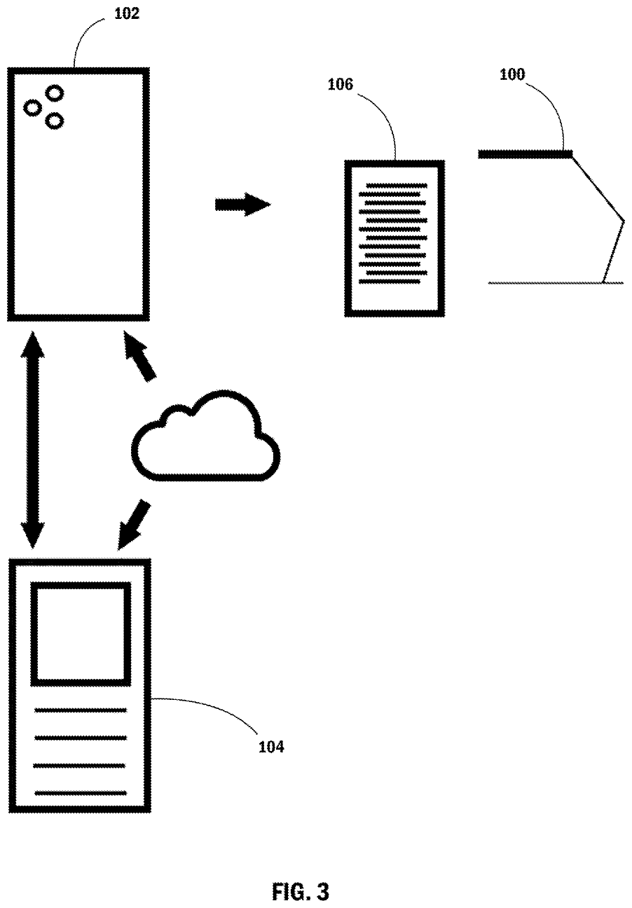

The illustrations of FIGS. 1-3 illustrate a method for the remote optimization of a task lamp that provides a practitioner the ability to alter task lamp lighting to suit a particular user in that user's environment without requiring the practitioner to be present in the same location. To effect such a method the practitioner and the user may be connected remotely, preferably via a video call, and the practitioner may be able to remotely control a task lamp set up by the user at their own location. The task lamp may be wirelessly connected to the practitioner via built-in hardware and a proprietary software, or may be wirelessly connected to the user via built-in hardware and a proprietary software that is connected to the practitioner's proprietary software. The task lamp may also be adjusted by the user independently.

A novel feature differentiating this invention from prior art is the ability to remotely select an optimum task lamp hue on a device such as a smart phone, tablet, or personal computer (PC) by eliciting feedback from a third-party viewing a visual sample that simulates properties of reading material or a task critical to optimizing visual performance. These properties can include features such as character size, contrast, and the color of an object. The optimized hue is communicated to the task lamp, which contains a processor running an algorithm to duplicate the optimized hue by driving colored light emitting diodes (LEDs).

The method for the remote optimization of a task lamp requires that a client user set up a task lamp 100 at a location of their choosing where the lighting will be applied. The task lamp 100 may emit a selection of colors, which may be manually selected or controlled by a proprietary software on a user device 102. Some task lamps 100 may be equipped with a range of light-emitting diodes (LEDs) only emitting various temperatures of white light because they are equipped with a combination of warm and cold white LEDs that may be simultaneously activated as desired. Other task lamps 100 may be equipped instead with combinations of red, green, and blue LEDs so that they can emit various hues, various temperatures of white light, or both.

The client user's task lamp 100 is connected to the user device 102 by any appropriate wired or wireless mechanism such as, for example, a cable connection or a wireless connection such as Bluetooth or WiFi. The user device 102 is then connected wirelessly to a practitioner device 104 by any appropriate wireless mechanism such as, for example, a wireless connection, a cellular connection, a cloud-based server, or an internet-based connection. The user device 102 and the practitioner device 104 may then establish a video link between themselves, allowing a user and a practitioner to communicate in real time. The practitioner device 104 may further comprise the ability to control the user device 102 or the task lamp 100 through a proprietary software installed on the various devices. The practitioner may additionally instruct the user to make changes directly on the user device 102 or the task lamp 100.

The task lamp 100 is illuminating a reference target 106, which may be any appropriate text such as, for example, a document, a newspaper, a seeing eye chart, or the like. The user may be viewing the reference target 106 under the task lamp 100 in the ambient lighting of their preferred environment. The practitioner may remotely make certain adjustments to the lighting of the task lamp 100, and the user may communicate to the practitioner whether or not such changes have improved or worsened the user's ability to read the reference target 106.

One embodiment additionally provides the ability to compare the selected background hue to a standard reference to verify the benefit of the optimized hue. An example of a standard reference is a white background of a set color temperature, such as 4500 degrees Kelvin (° K). Another example is a colored background that remains constant during the optimization process. Another example is a picture of a colored object such as a ball of yarn illuminated with 5000° K white light. Another example is a chart with characters of known contrast with respect to the chart's background. The function of the standard reference is to enable the user to compare the effect of different hue choices against a hue that remains constant. This allows the user to verify that a newly selected hue, in fact, improves visual performance over that obtained with the standard reference.

In one embodiment, the task lamp is manually controlled. In another embodiment, the lamp is controlled using a software code running on a smart device or computer connected to the lamp using either a wired connection such as USB, or a wireless connection such as Bluetooth or WiFi.

The user's task lamp is at a location remote from the practitioner; for example, the user is at home or in an office and the practitioner is in their office or home. The user will typically be at the location where the lamp is intended to be used. The user and practitioner are in communication. In one embodiment, this is a video link, as is readily available via a smart phone or internet connected computer with apps such as Skype, Zoom or FaceTime.

In addition, the practitioner has a means for setting the color and intensity of the lamp. In one embodiment the means is by instructing the user, who makes adjustments to the lamp color and intensity. In another embodiment, the means is through a network connection between the practitioner and the user's device, which may be a computer, or smart device such as a phone or tablet, whereby the practitioner sets the lamp color and intensity remotely based on feedback gained from sources such as user feedback, measurement data, and observations made through a video connection. For example, the user reports that the lamp is too dim and the practitioner increases the lamp brightness in response. In another example, the practitioner sets the lamp to a white color and then a green color, and the user reports that text on a newspaper are easier to read with the green color than with the white color. In another example, the user reports that a table setting is easier to see under yellow light than under white light. Through this process, the practitioner can iterate lamp parameters such as color, intensity and position until one or more set of parameters are found that optimize visual performance. In another embodiment, multiple desired combinations of hue and intensity are found and saved as settings for the lamp from which the user can later select. Such selection may be, for example, through use of the user's smart device, or through a control or button on the lamp.

In one embodiment, the user observes a reference target or pattern that the lamp illuminates. This can be a standard reference such as, for example, an eye chart, contrast chart, or chart with symbols or patterns provided by the practitioner. In another embodiment, this is reference reading material such as a newspaper or book. In another embodiment, this is material associated with a functional task, such as labeled pill bottles or a table setting.

In another embodiment, the user's smart device or computer includes an app that measures a parameter of the lighting. In one embodiment, this measurement is made using a camera built into the smart device or computer. In another embodiment, the measurement is made using a device connected to the computer or smart device, such as a remote camera or light meter. In another embodiment, the measurement device is independent of the user's computer or smart device and readings are reported by the user or viewed through a video connection between the user and the practitioner.

In another embodiment, the practitioner's device has one or more programs that provide analysis of data that may be input by the practitioner, or may analyze images of material illuminated by the lamp. For example, the practitioner may capture a screen shot of reading material or a test pattern illuminated by the lamp, and a program may analyze the image to determine the perceived contrast, which directly relates to glare. The practitioner may then ask the patient to move the lamp to a position where the glare is reduced and the perceived contrast increased. In another example, the practitioner may input the lamp intensity settings for each of the lamp's primary colors (red, green, blue or warm and cold white) and the distance from the head of the lamp to the work surface in order to determine the lamp intensity. In another example, a color screen shot of the work surface is manipulated to determine the hue that provides the best color contrast.

One or more parameters may be measured. Examples include glare, contrast, color contrast, and light intensity. For example, an app running on a smart device may measure perceived contrast between light and dark regions or regions of different colors. The measurement is reported to the practitioner, and the lamp color, intensity, or position are adjusted to maximize perceived contrast. In one embodiment, the user has a test chart such as, for example, a pattern of alternating bars that is illuminated with the lamp. Note that in some cases parameters may be related. For example, glare is greater at higher intensity, and high glare will result in poor perceived contrast. Note also that in some cases a determination of the intensity by a method other than a direct measurement may be preferred, such as a calculation of intensity at the work surface based on the distance between the lamp and the work surface, as the sensitivity of a light meter may have a complex dependence on the hue.

FIG. 1 shows a flow chart of an example of the intended method. First, a connection is established between the practitioner and the user. This may be in the form of a voice or video link, as described above. The lamp is then set up in the intended location and turned on. Reference material is placed under the lamp in the position that would be occupied during normal use of the lamp. The reference material may be, for example, an eye chart, a chart with symbols, a book or newspaper, or objects related to a functional task. The lamp is then set to a combination of color and intensity, and a measure of visual performance is made. This measure can be a qualitative observation by the user or measured using a method such as analyzing a screen shot of the illuminated area or object for a visual property, and may be of a parameter such as, for example, intensity, perceived contrast or ability to resolve letters or characters. If visual performance is at a desired level, the setting is saved. If not a new combination of color, intensity or lamp position is set and the measurement of performance repeated. Note that even if one desired setting is found, the process may be repeated to find additional settings to save.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A method for the remote optimization of a task lamp, comprising:
setting up a task lamp at a client user location;
illuminating a reference target with said task lamp by said client user;
connecting said task lamp to a client device;
connecting said client device to a practitioner device;
modifying a plurality of settings of said task lamp by a practitioner using said practitioner device;
analyzing a difference in light output illuminating said reference target by said client user;
receiving feedback from said client user regarding said difference in light output by said practitioner user; and
saving said plurality of settings of said task lamp based on said client user feedback.

2. The method of claim 1,
wherein said client user is located remotely from said practitioner user.

3. The method of claim 2,
wherein said task lamp, said client device, and said practitioner device comprise a proprietary software.

4. The method of claim 3,
wherein a camera on said user device captures an image of said reference target;
wherein said proprietary software measures a plurality of parameters of light from said image of said reference target;
wherein said plurality of parameters are reported to said practitioner user via said practitioner device; and
wherein said practitioner user modifies said plurality of settings of said task lamp based on said plurality of parameters.

5. The method of claim 4,
wherein said client user modifies said plurality of settings of said task lamp.

6. The method of claim 4,
wherein one of said plurality of settings comprises a perceived contrast.

7. The method of claim 4,
wherein one of said plurality of settings comprises a color contrast.

8. The method of claim 4,
wherein one of said plurality of settings comprises an intensity.

9. The method of claim 4,
wherein one of said plurality of settings comprises a hue.

10. The method of claim 4,
wherein one of said plurality of settings comprises a lamp position.

11. The method of claim 4,
wherein said reference target comprises a page of text.

12. The method of claim 4,
wherein said reference target comprises a contrast chart.

13. The method of claim 4,
wherein said reference target comprises a reading chart.

14. The method of claim 4,
wherein said reference target comprises a colored object.
